(19) United States
(12) Patent Application Publication
(10) Pub. No.: US 2015/0143286 A1
(43) Pub. Date: May 21, 2015

(54) METHOD AND TERMINAL FOR RESPONDING TO SLIDING OPERATION

(71) Applicant: Xiaomi Inc., Beijing (CN)

(72) Inventors: Cai Zhu, Beijing (CN); Weixing Li, Beijing (CN); Daqing Sun, Beijing (CN)

(73) Assignee: Xiaomi Inc.

(21) Appl. No.: 14/473,226

(22) Filed: Aug. 29, 2014

Related U.S. Application Data
(63) Continuation of application No. PCT/CN2014/077480, filed on May 14, 2014.

(30) Foreign Application Priority Data
Nov. 20, 2013 (CN) 201310586018.X

(51) Int. Cl. G06F 3/0484; G06F 3/0488

(52) U.S. Cl. CPC G06F 3/04847; G06F 3/0488
USPC 715/799

(57) ABSTRACT

There is provided a method for responding to a sliding operation for use in a terminal having a touch screen and operating on an operating system including a system process, an application process, and an interface delivery process, wherein the application process is configured to draw a display content in a size larger than a size of the touch screen. The method includes: when the system process detects the sliding operation, acquiring a sliding distance and a sliding direction of the sliding operation; transmitting the sliding distance and the sliding direction of the sliding operation to each of the application process and the interface delivery process; when the interface delivery process receives the sliding distance and the sliding direction, moving a display window in the sliding direction, according to the sliding distance; and controlling the touch screen to display a display content corresponding to the moved display window.

### CROSS REFERENCE TO RELATED APPLICATIONS

This application is a Continuation of International Application No. PCT/CN2014/077480, filed May 14, 2014, which claims priority to Chinese Patent Application No. 201310586018.X, filed Nov. 20, 2013, the entire contents of all of which are incorporated herein by reference.

### TECHNICAL FIELD

The present disclosure generally relates to the field of terminal technology and, more particularly, to a method and a terminal for responding to a sliding operation.

### BACKGROUND

For program windows of a touch-screen terminal, performing a sliding operation, e.g., by sliding a finger upward or downward, has become a standard operation mode for scrolling a screen.

Conventionally, an operating system of the touch-screen terminal, such as an Android operating system, may include a system process, an application process, and an interface delivery process. When responding to a sliding operation, interactions among the system process, the application process and the interface delivery process include that the system process receives the sliding operation and transmits a message of the sliding operation to the corresponding application process. The application process draws window contents according to the message of the sliding operation, and transmits the drawn window contents to the interface delivery process. Then the interface delivery process triggers to refresh the screen, and outputs the window contents onto the screen.

The above method generally takes a relatively long time from when the system access acquires the sliding operation to when processing results corresponding to the sliding operation are output onto the screen, which results in a delay in displaying the window contents onto the screen.

### SUMMARY

According to a first aspect of the present disclosure, there is provided a method for responding to a sliding operation for use in a terminal having a touch screen and operating on an operating system including a system process, an application process, and an interface delivery process, wherein the application process is configured to draw a display content in a size larger than a size of the touch screen, the method comprising: when the system process detects the sliding operation, acquiring a sliding distance and a sliding direction of the sliding operation; transmitting, by the system process, the sliding distance and the sliding direction of the sliding operation to each of the application process and the interface delivery process; when the interface delivery process receives the sliding distance and the sliding direction, moving a display window in the sliding direction, according to the sliding distance; and controlling, by the interface delivery process, the touch screen to display a display content corresponding to the moved display window.

According to a second aspect of the present disclosure, there is provided a terminal for responding to a sliding operation, comprising: a processor; a touch screen coupled to the processor; and a memory for storing an operating system including a system process, an application process, and an interface delivery process, wherein: the application process is configured to draw a display content in a size larger than a size of the touch screen; the system process, when detecting the sliding operation, acquires a sliding distance and a sliding direction of the sliding operation; the system process transmits the sliding distance and the sliding direction of the sliding operation to each of the application process and the interface delivery process; the interface delivery process, when receiving the sliding distance and the sliding direction, moves a display window in the sliding direction, according to the sliding distance; and the interface delivery process controls the touch screen to display a display content corresponding to the moved display window.

According to a third aspect of the present disclosure, there is provided a non-transitory storage medium having stored therein instructions regarding an operating system that, when executed by a processor of a terminal, cause the terminal to perform a method for responding to a sliding operation, the terminal having a touch screen, and the operating system including a system process, an application process, and an interface delivery process, wherein the application process is configured to draw a display content in a size larger than a size of the touch screen, the method comprising: when the system process detects the sliding operation, acquiring a sliding distance and a sliding direction of the sliding operation; transmitting, by the system process, the sliding distance and the sliding direction of the sliding operation to each of the application process and the interface delivery process; when the interface delivery process receives the sliding distance and the sliding direction, moving a display window in the sliding direction, according to the sliding distance; and controlling, by the interface delivery process, the touch screen to display a display content corresponding to the moved display window.

It is to be understood that both the foregoing general description and the following detailed description are exemplary only and are not restrictive of the present invention.

### BRIEF DESCRIPTION OF THE DRAWINGS

The accompanying drawings, which are hereby incorporated in and constitute a part of this specification, illustrate embodiments consistent with the invention and, together with the description, serve to explain the principles of the invention.

FIG. 1 is a flow chart of a method for responding to a sliding operation, according to an exemplary embodiment.

FIG. 2 is a diagram of a method for responding to a sliding operation, according to an exemplary embodiment.

FIG. 3 is a diagram illustrating a method for responding to a sliding operation, according to an exemplary embodiment.

FIG. 4 is a diagram illustrating time contrast of a sliding operation response, according to an exemplary embodiment.

FIG. 5 is a block diagram of a device for responding to a sliding operation, according to an exemplary embodiment.

FIG. 6 is a block diagram of a terminal, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

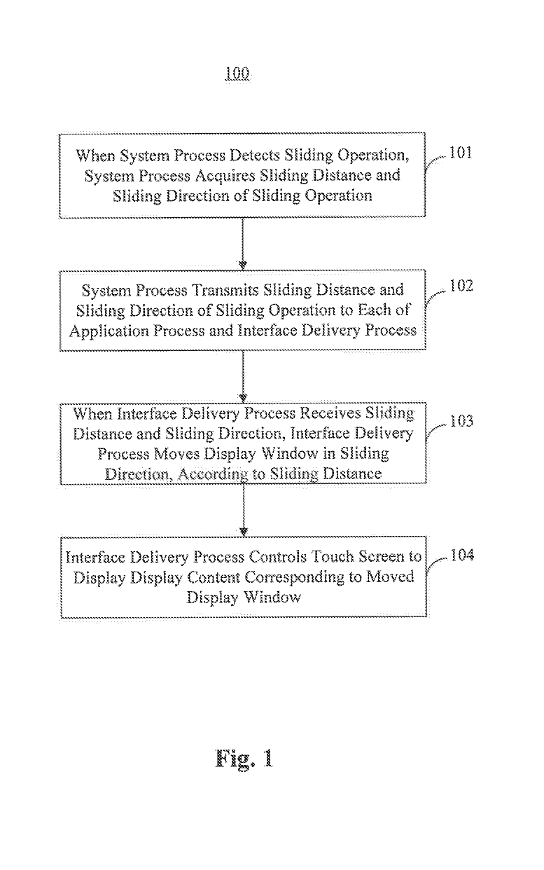

FIG. 1 is a flowchart of a method 100 for responding to a sliding operation, according to an exemplary embodiment. For example, the method 100 can be applied to a terminal having a touch screen, and operating on an operating system including a system process, an application process, and an interface delivery process. The system process, the application process, and the interface delivery process can each be implemented with software, hardware, or a combination thereof. The application process is configured to draw a display content in a size larger than a size of the touch screen. In one exemplary embodiment, the application process draws the display content by generating the display content with the larger size in a memory. Referring to FIG. 1, the method 100 includes the following steps.

In step 101, when the system process detects the sliding operation, a sliding distance and a sliding direction of the sliding operation are acquired.

In step 102, the system process transmits the sliding distance and the sliding direction of the sliding operation to each of the application process and the interface delivery process.

In step 103, when the interface delivery process receives the sliding distance and the sliding direction, a display window is moved in the sliding direction, according to the sliding distance.

In step 104, the interface delivery process controls the touch screen to display a display content corresponding to the moved display window.

In the method 100, the application process draws the display content in a size larger than the size of the touch screen. When the system process detects the sliding operation, the system process transmits related data of the sliding operation to the application process and the interface delivery process, triggers the interface delivery process to move a display window on the drawn display content, so as to control the touch screen to display the display content indicated by the sliding operation. Thus, the time that the interface delivery process waits for the application process to draw is reduced, and a response speed of the sliding operation is increased, such that synchronization of screen display and the sliding operation is enhanced.

In one exemplary embodiment, when the application process determines that a display content indicated by the sliding distance exceeds the display content drawn by the application process, the application process drawing an excess portion of the display content indicated by the sliding distance according to the sliding distance and the display content. In one exemplary embodiment, the application process draws the excess portion of the display content by generating the excess portion in the memory. The application process transmits the excess portion to the interface delivery process. Correspondingly, when the interface delivery process receives the excess portion, the interface delivery process controls the touch screen to display the display content corresponding to the display window that has been moved and the excess portion.

In one exemplary embodiment, when the application process transmits the excess portion to the interface delivery process, the application process transmits a position identification of the excess portion to the interface delivery process. Correspondingly, the interface delivery process controls the touch screen to display the display content corresponding to the display window that has been moved and the excess portion, according to the position identification of the excess portion.

In one exemplary embodiment, when the interface delivery process receives the sliding distance and the sliding direction, the interface delivery process moves the display window by the sliding distance in the sliding direction.

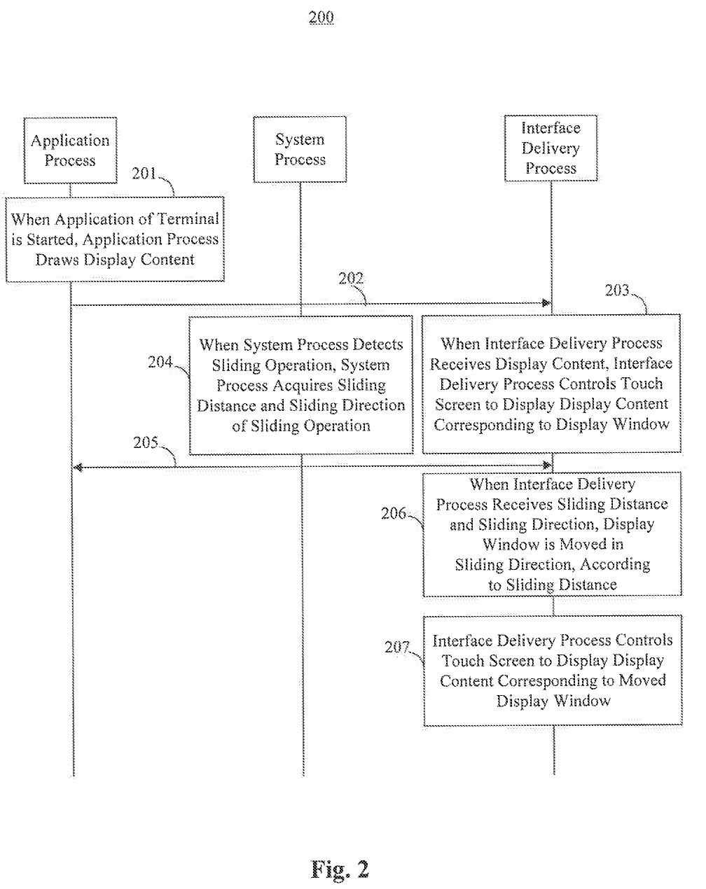

FIG. 2 is a diagram of a method 200 for responding to a sliding operation, according to an exemplary embodiment. For example, the method 200 is applied to a terminal having a touch screen, and operating on an operating system including a system process, an application process, and an interface delivery process. Referring to FIG. 2, the method 200 includes the following steps.

In step 201, when an application of the terminal is started, the application process draws a display content. For example, the application process draws the display content by generating the display content in a memory.

In exemplary embodiments, each application process serves for one application, and the application process is configured to draw a display content of the application corresponding to the application process. The display content is displayed on an interface of the application. The display content of the application includes, but is not limited to, a background of the application and various objects of the application and the like. For a desktop when the terminal is started, the operating system of the terminal also has an application process that serves for the desktop in order to draw the desktop.

In exemplary embodiments, a size of the display content is larger than a size of the touch screen, and the size of the display content may be a preset multiple of the size of the touch screen. The preset multiple may also be adjusted during use. For example, the preset multiple may be 1.2 times, to avoid a large size of the display content occupying too much space of a memory of the terminal.

In step 202, the application process transmits the drawn display content to the interface delivery process.

In the present disclosure, the interface delivery process is configured to display received display content, and move a display window on the drawn display content, to control the display content on the touch screen. The display window is configured to identify the display content on the touch screen, that is, a content corresponding to the display window is the display content on the touch screen.

In one exemplary embodiment, when the application process transmits the drawn display content to the interface delivery process, the application process may also simultaneously transmit a position identification of the drawn display content to the interface delivery process. The position identification may be coordinates. For example, the position identification of the display content is (1, 10)˜(1, 60).

In step 203, when the interface delivery process receives the display content, the interface delivery process controls the touch screen to display the display content corresponding to the display window.

In the present embodiment, since the size of the display content is larger than the size of the touch screen, the touch screen may display a portion of the display content. When the interface delivery process receives the display content, the interface delivery process controls the touch screen to display the content which corresponds to the display window and is to be displayed when the terminal is initially started. In one exemplary embodiment, the position identification of the display content is (1, 10)˜(1, 60), a position identification of the content that is to be displayed when the terminal is initially started is (1, 10)˜(1, 50), and the interface delivery process controls the touch screen to display the content corresponding to the display window and having the position identification of (1, 10)˜(1, 50).

In step 204, when the system process detects a sliding operation, the system process acquires a sliding distance and a sliding direction of the sliding operation.

The system process is configured to transmit related data of the sliding operation to the application process and the interface delivery process, when the system process detects the sliding operation.

The sliding operation may be a sliding operation on an operating interface of the application. For example, when a picture is displayed, the sliding operation is an operation of dragging the picture in a certain direction by a user through the operating interface, or when a web content is displayed using a browser, the sliding operation may also be an operation of dragging the web content in a certain direction by a user through an operating interface.

In the present embodiment, when the system process detects the sliding operation, the system process may acquire the sliding distance and the sliding direction of the sliding operation according to a trajectory character input by a gesture of the sliding operation.

In the present embodiment, when the system process detects the sliding operation, the sliding distance and the sliding direction of the sliding operation are acquired. In another embodiment, when the system process detects that a direction control button is triggered, a distance and a direction corresponding to the direction control button are acquired. While the direction control button is configured to control the display content of the touch screen to move a preset distance in a preset direction, the embodiment of the present disclosure does not limit the preset direction and a value of the preset distance.

In step 205, the system process transmits the sliding distance and the sliding direction of the sliding operation to each of the application process and the interface delivery process, so that when the interface delivery process receives the sliding distance and the sliding direction of the sliding operation, the interface delivery process controls the touch screen to display a display content indicated by the sliding distance, without waiting for the application process to transmit the display content drawn by the application process, thus a response speed of the sliding operation is increased.

In step 206, when the interface delivery process receives the sliding distance and the sliding direction, the display window is moved in the sliding direction, according to the sliding distance.

In one exemplary embodiment, when the display content indicated by the sliding distance does not exceed the display content drawn by the application process, the display content that has been drawn by the application process may satisfy a current display requirement of the sliding operation. When the interface delivery process receives the sliding distance and the sliding direction, the display window is moved by the sliding distance in the sliding direction. For example, when the sliding distance of the sliding operation is 1 cm, and the sliding direction is in a horizontal-left direction, the interface delivery process moves the display window by 1 cm in the horizontal-left direction.

In one exemplary embodiment, when the display content indicated by the sliding distance exceeds the display content drawn by the application process, the display content drawn by the application process may not satisfy the current display requirement of the sliding operation. Thus, the application process receives the sliding distance and the sliding direction, and determines that the display content indicated by the sliding distance exceeds the display content drawn by the application process. The application process draws an excess portion of the display content indicated by the sliding distance according to the sliding distance and the display content, and transmits the excess portion and a position identification of the excess portion to the interface delivery process. In one exemplary embodiment, the application process draws the excess portion of the display content by generating the excess portion in the memory. When the application process receives the excess portion and the position identification of the excess portion, the display window is moved by the sliding distance in the sliding direction, so that the display window that has been moved corresponds to the display content and the excess portion. At this time, the interface delivery process displays a portion of the drawn display content together with the excess portion. The portion of the drawn display content may be displayed firstly and, then, the excess portion, when being received, is displayed based on the portion of the drawn display content being displayed. Thus, the response speed is increased to ensure a display effect.

For example, the position identification of the display content drawn by the application process is (1, 50)˜(1, 60), and the position identification of the display content indicated by the sliding distance is (1, 50)˜(1, 100). Thus, the content having the position identification of (1, 60)˜(1, 100) is the excess portion. When the interface delivery process receives the content having the position identification of (1, 60)˜(1, 100) of the excess portion, the display window is moved by the sliding distance in the sliding direction, such that the display window that has been moved corresponds to the display content having the position identification of (1, 50)˜(1, 60) and the content having the position identification of (1, 60)˜(1, 100) of the excess portion.

Further, in one exemplary embodiment, based on the excess portion of the display content indicated by the sliding distance, the application process may also draw an extra portion of display content (for example, 1.2 times the excess portion), so that when the system process detects another sliding operation, the interface delivery process controls the touch screen to display the extra drawn display content. Thus, a waiting time for the application process to transmit the drawn display content is reduced, and a response speed of the sliding operation is increased.

In the illustrated embodiment, the sliding distance of the sliding operation is assumed to be the same as a moving distance of the display window. In other embodiments, according to different system configures, the sliding distance of the sliding operation may be proportional to the moving distance of the display window. For example, the sliding distance of the sliding operation is 1 cm, and the moving distance of the display window is 2 cm.

In step 207, the interface delivery process controls the touch screen to display a display content corresponding to the moved display window.

In one exemplary embodiment, when the display content indicated by the sliding distance does not exceed the display content drawn by the application process, the display window that has been moved corresponds to the display content, and the interface delivery process controls the touch screen to display the display content corresponding to the display window that has been moved.

In one exemplary embodiment, when the display content indicated by the sliding distance exceeds the display content drawn by the application process, the display window that has been moved corresponds to the display content and the excess portion, and the interface delivery process controls the touch screen to display the display content corresponding to the display window that has been moved and the excess portion.

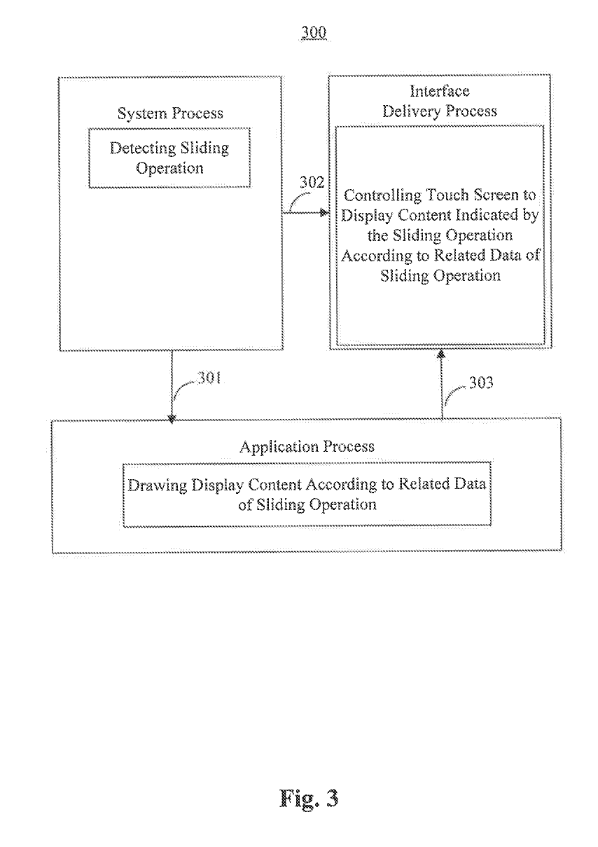

FIG. 3 is a diagram illustrating a method 300 for responding to a sliding operation, according to an exemplary embodiment. Referring to FIG. 3, when the system process detects the sliding operation, the system process transmits related data of the sliding operation to the application process (301) and to the interface delivery process (302). When the display content indicated by the sliding distance does not exceed the display content drawn by the application process, the interface delivery process controls the touch screen to display the display content indicated by the sliding distance. When the display content indicated by the sliding distance exceeds the display content drawn by the application process, the application process draws a content of the excess portion, and transmits the content of the excess portion to the interface delivery process (303), so that the interface delivery process controls the touch screen to display the display content indicated by the application process and the content of the excess portion. Thus, a waiting time for the application process to transmit the display content drawn by the application process and indicated by the sliding operation is reduced, and a response speed of the sliding operation is increased.

Compared to the related art, the above described methods for responding to the sliding operation reduce a time from the sliding operation being input to display content being output on the screen. For example, assuming that the size of the display content is 1.2 times larger than the size of the touch screen, for an apparatus of 60 frames/second, the time from the sliding operation being input to display content being output on the screen may be reduced by 16.6 milliseconds.

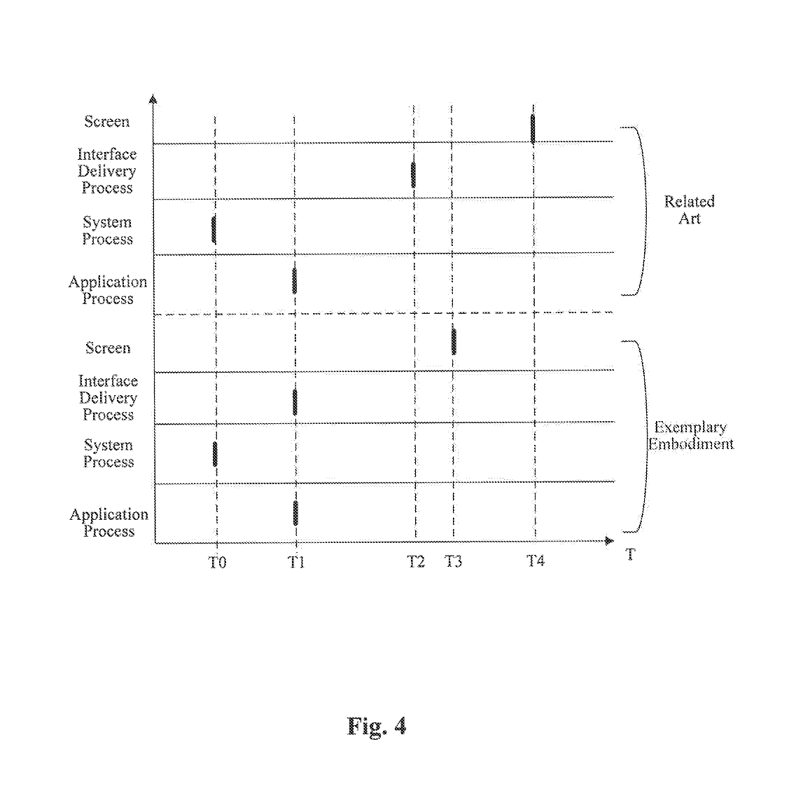

FIG. 4 is a diagram illustrating time contrast of sliding operation responses between related art and an exemplary embodiment of the above described methods. Referring to FIG. 4, in the related art, at timing T0, the system process detects the sliding operation; at timing T1, the application process receives related data of the sliding operation, and draws the display image; at timing T2, the interface delivery process processes the display content; and at timing T4, the screen displays the display content indicated by the sliding operation. In the exemplary embodiment, at timing T0, the system process detects the sliding operation; at timing T1, the application process receives related data of the sliding operation, and draws the display content and, at the same timing T1, the interface delivery process receives the related data of the sliding operation, and processes the display content; at timing T3, the screen displays the display content indicated by the sliding operation. Thus, when the sliding operation is detected at the same time, compared to the related art, the above described methods for responding to a sliding operation reduce a time from the sliding operation being input to the display content being output on the screen.

In the above described methods for responding to a sliding operation, with the application process drawing a display content in a size larger than a size of the touch screen, when the system process detects a sliding operation, the system process transmits related data of the sliding operation to the application process and the interface delivery process, triggers the interface delivery process to move a display window on the drawn display content, so as to control the touch screen to display a display content indicated by the sliding operation. Thus, the time that the interface delivery process waits for the application process to draw is reduced, and a response speed of the sliding operation is increased, such that synchronization of screen display and the sliding operation is enhanced.

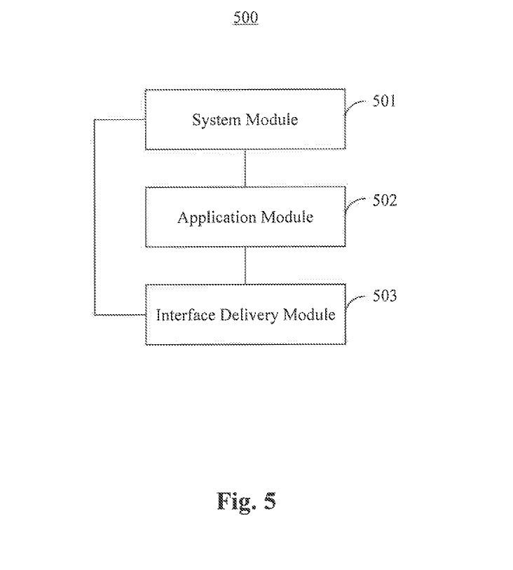

FIG. 5 is a block diagram of a device 500 for responding to a sliding operation, according to an exemplary embodiment. For example, the device 500 may be used in a terminal having a touch screen. Referring to FIG. 5, the device 500 includes a system module 501, an application module 502, and an interface delivery module 503.

The application module 502 is configured to draw a display content in a size larger than a size of the touch screen.

The system module 501 is connected with the application module 502 and the interface delivery module 503, and the application module 502 is connected with the interface delivery module 503. When the system module 501 detects the sliding operation, the system module 501 acquires a sliding distance and a sliding direction of the sliding operation. The system module 501 transmits the sliding distance and the sliding direction of the sliding operation to the application module 502 and the interface delivery module 503. When the interface delivery module 503 receives the sliding distance and the sliding direction, the interface delivery module 503 moves a display window in the sliding direction, according to the sliding distance, and controls the touch screen to display a display content corresponding to the display window that has been moved.

In one exemplary embodiment, when the application module 502 determines that the display content indicated by the sliding distance exceeds the display content drawn by the application module, the application module 502 draws an excess portion of the display content indicated by the sliding distance according to the sliding distance and the display content, and transmits the excess portion to the interface delivery module. Correspondingly, when the interface delivery module 503 receives the excess portion, the interface delivery module 503 controls the touch screen to display the display content corresponding to the display window that has been moved and the excess portion.

In one exemplary embodiment, when the application module 502 transmits the excess portion to the interface delivery module 503, the application module 502 transmits a position identification of the excess portion to the interface delivery module 503. Correspondingly, the interface delivery module 503 controls the touch screen to display the display content corresponding to the display window that has been moved and the excess portion, according to the position identification of the excess portion.

In one exemplary embodiment, when the interface delivery module 503 receives the sliding distance and the sliding direction, the interface delivery module 503 moves the display window by the sliding distance in the sliding direction.

By using the device 500, a response speed of the sliding operation is increased, such that synchronization of screen display and the sliding operation is enhanced.

The division of the modules in the above embodiment is for illustrative purposes only and, in actual applications, the above operations may be performed by different modules as needed. That is, the internal structure of the device 500 can be divided into different modules, to perform all or a part of the above-described operations.

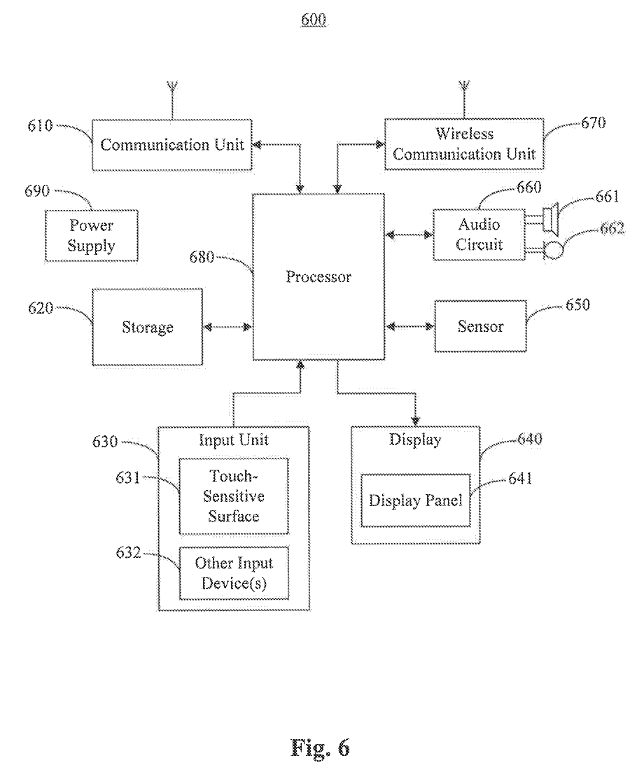

FIG. 6 is a block diagram of a terminal 600, according to an exemplary embodiment. Referring to FIG. 6, the terminal 600 is configured to perform the above described methods to responding to a sliding operation.

Referring to FIG. 6, the terminal 600 may include one or more of a communication unit 610, a storage 620 including one or more computer readable storage media, an input unit 630, a display 640, a sensor 650, an audio circuit 660, a wireless fidelity (WiFi) module 670, a processor 680 including one or more processing cores, and a power supply 690 or the like. Those skilled in the art will understand that the structure shown in FIG. 6 is not restrictive to the terminal 600, and the terminal 600 may include more or less components than those of FIG. 6, or may combine certain components, or may have different arrangements of components.

The communication unit 610 is configured to receive and send signals in reception and sending of information or in a process of phone calling. The communication unit 610 may be a network communication apparatus such as a radio frequency (RF) circuit, a router, a modem. For example, when the communication unit 610 is the RF circuit, after receiving downlink information from a base station, the downlink information is processed by the processor 680. In addition, uplink data is sent to the base station. Generally, the RF circuit as the communication unit 610 includes an antenna, at least one amplifier, a tuner, one or more oscillators, a subscriber identity module (SIM) card, a transceiver, a coupler, a low noise amplifier (LNA) and a duplexer, etc., but it is not limited thereto. Furthermore, the communication unit 610 may also communicate with a network and other apparatuses by wireless communication. The wireless communication may use any communication standard or protocol including global system of mobile communication (GSM), general packet radio service (GPRS), code division multiple access (CDMA), wideband code division multiple access (WCDMA), long term evolution (LTE), E-mail, short messaging service (SMS) or the like, but not limited thereto.

The storage 620 is configured to store software programs and modules, and the processor 680 executes various kinds of function applications and data processing by executing the software programs and modules stored in the storage 620. The storage 620 may mainly include a program storing area and a data storing area, wherein the program storing area may store an operating system, at least one application program required for functions such as a sound playing function, an image playing function or the like. The data storing area may store data such as audio data and a telephone book, etc., generated in accordance with the use of the terminal 600. Furthermore, the storage 620 may include a high speed random access memory or a nonvolatile memory, for example, at least one magnetic disk storage device, a flash memory device or other nonvolatile solid-state memory devices. Correspondingly, the storage 620 may also include a storage controller, to provide the processor 680 and the input unit 630 with access to the storage 620.

The input unit 630 is configured to receive figures or character information that are input, and generate signal input of a keyboard, a mouse, a joystick, an optical device or a trackball related to user settings and function control. For example, the input unit 630 may include a touch-sensitive surface 631 and one or more other input devices 632. The touch-sensitive surface 631, which is also referred to as a touch display screen or a touch panel, may collect touch operations from a user thereon or nearby (for example, operations on the touch-sensitive surface 631 or near the touch-sensitive surface 631 by a user using any appropriate object or accessory such as a finger, or a touch pen, etc.), and may drive a corresponding connected device according to a preset program. The touch-sensitive surface 631 may include first and second portions, i.e., a touch detection device and a touch controller. The touch detection device detects touch orientations of a user, and detects signals caused by touch operations, then transmits the signals to the touch controller. The touch controller receives touch information from the touch detection device, and converts the touch information into coordinates of touch points to be sent to the processor 680, and the touch controller receives commands sent from the processor 680 and executes the commands. Furthermore, the touch-sensitive surface 631 may be realized by in various types, such as a resistive type, a capacitive type, an infrared type, or a surface acoustic wave type, and the like. In addition to the touch-sensitive surface 631, the input unit 630 may also include one or more other input devices 632. The other input devices 632 may include one or more physical keyboards, a function key (such as a volume control key, or a switching key, etc.), a trackball, a mouse and a joystick, but it is not limited thereto.

The display 640 is configured to display information input by a user or information supplied to the user and various kinds of graphical user interfaces of the terminal 600. The graphical user interfaces may consist of graph, text, icon, video or any combination thereof. The display 640 may include a display panel 641, which may be configured by using a liquid crystal display (LCD), an organic light-emitting diode (LCD) and the like. Further, the touch-sensitive surface 631 may cover the display panel 641, and after the touch-sensitive surface 631 detects touch operations thereon or nearby, the touch-sensitive surface 631 transmits the touch operations to the processor 680 to determine types of touch operations. Subsequently, the processor 680 provides a corresponding visual output on the display panel 641 according to the types of the touch operations. In FIG. 6, although the touch-sensitive surface 631 and the display panel 641 are two separate parts to realize input and output functions, in some certain embodiments, the touch-sensitive surface 631 and the display panel 641 may be integrated to realize the input and output functions.

The sensor 650 may be a light sensor, a motion sensor, or any other sensors. For example, the light sensor may include an ambient light sensor and a proximity sensor. The ambient light sensor may adjust luminance of the display panel 641 according to luminance of ambient light, the proximity sensor may turn off the display panel 641 and/or its backlight when the terminal 600 moves to the user's ear. As an example of the motion sensor, a gravity acceleration sensor may detect magnitudes of an acceleration on respective directions, e.g., along three axes, and detect a value and a direction of the gravity when in stationary state. The gravity acceleration sensor is configured to recognize applications relating to an orientation of the terminal 600 (for example, horizontal and vertical screen switching, related games, magnetometer gesture calibration), vibration-recognizing related functions (for example, a pedometer, knocking) and the like. The terminal 600 may also be configured with other sensors such as a gyro, a barometer, a hygrometer, a thermometer, an infrared sensor and the like.

The audio circuit 660 is coupled to a speaker 661 and a microphone 662, and may provide an audio interface between the user and the terminal 600. The audio circuit 660 may convert received audio data into electrical signals and transmit the electrical signals to the speaker 661, then the speaker 661 converts the electrical signals into sound signals to be output. On the other hand, the microphone 662 converts collected sound signals into electrical signals, and the audio circuit 660 receives the electrical signals and converts the electrical signals into audio data. The audio data is output to the processor 680 to be processed, and then sent to another terminal through the RF circuit as the communication unit 610, or the audio data is output to the storage 620 to be further processed. The audio circuit 660 may include an earplug jack, to provide communication between a peripheral headset and the terminal 600.

The wireless communication unit 670 may be a WiFi module configured to provide wireless broadband Internet access, which allows the user to receive and send emails, browse webpages, and access streaming media. Although FIG. 6 shows the wireless communication unit 670, it shall be understood that the terminal 600 does not have to include the wireless communication unit 670, and the wireless communication unit 670 may be omitted as needed.

The processor 680 is a control center of the terminal 600 that couples to respective components of the terminal 600 by using various kinds of interfaces and circuits, and executes various functions of the terminal 600 and processes data by operating or executing software programs and/or modules stored in the storage 620 and calling data stored in the storage 620. The processor 680 may include one or more processing cores, and may integrate an application processor and a modem processor. The application processor mainly processes an operating system, a user interface and an application program, and the modem processor mainly processes wireless communication. In some embodiments, the modem processor may not be integrated into the processor 680.

The power supply 690 is configured to supply power to components of the terminal 600. The power supply may be logically coupled with the processor 680 by a power supply management system, thereby realizing functions such as management of charging, discharging and power consumption by the power supply management system. The power supply 690 may also include one or more of a direct current (DC) power supply, an alternating current (AC) power supply, a rechargeable system, a power supply malfunction detecting circuit, a power supply converter, an inverter, a power supply state indicator and the like.

Although not shown, the terminal 600 may also include a camera, or a Bluetooth module, etc.

In exemplary embodiments, the terminal 600 may be various handheld terminals, such as a mobile phone, a personal digital assistant (PDA) and the like. The scope of the present disclosure is not limited to a particular type of terminal.

In exemplary embodiments, there is also provided a non-transitory readable storage medium including instructions, such as included in the storage 620, executable by the processor 680 in the terminal 600, for performing the above-described methods for responding to a sliding operation. For example, the non-transitory readable storage medium may be a read-only memory (ROM), a programmable ROM (PROM), an electrically programmable read-only memory ROM (EPROM), an electrically erasable programmable ROM (EEPROM), a flash memory, a hard disk, a removable disk, a CD-ROM, or any other storage media.

In some embodiments, the above described methods may be implemented by a central processing unit (CPU) executing a computer program. In some embodiments, the above described methods may be implemented with a controller and a computer-readable storage device which stores a computer program.

Various illustrative logical blocks and modules described in conjunction with the present disclosure may be implemented or performed by the following components that are designed to perform the above functions: a general purpose processor, a digital signal processor (DSP), an application-specific integrated circuit (ASIC), a field programmable gate array (FPGA) or other programmable logic devices, discrete gates or transistor logics, discrete hardware components or any combination of these components. The general purpose processor may be a microprocessor. Alternatively, the processor may be any one of a conventional processor, a controller, a microcontroller, or a state machine. The processor may be implemented as combination of computing devices, such as combination of a DSP and a microprocessor, a plurality of microprocessors, one or more microprocessors in conjunction with a DSP core, or any other such configuration.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for responding to a sliding operation for use in a terminal having a touch screen and operating on an operating system including a system process, an application process, and an interface delivery process, wherein the application process is configured to draw a display content in a size larger than a size of the touch screen, the method comprising:
when the system process detects the sliding operation, acquiring a sliding distance and a sliding direction of the sliding operation;
transmitting, by the system process, the sliding distance and the sliding direction of the sliding operation to each of the application process and the interface delivery process;
when the interface delivery process receives the sliding distance and the sliding direction, moving a display window in the sliding direction, according to the sliding distance; and
controlling, by the interface delivery process, the touch screen to display a display content corresponding to the moved display window.

2. The method according to claim 1, further comprising:
when the application process determines that a display content indicated by the sliding distance exceeds the display content drawn by the application process, drawing an excess portion of the display content indicated by the sliding distance according to the sliding distance and the display content; and
transmitting, by the application process, the excess portion to the interface delivery process.

3. The method according to claim 2, wherein the controlling of the touch screen to display the display content comprises:
when the interface delivery process receives the excess portion, controlling, by the interface delivery process, the touch screen to display the display content corresponding to the moved display window and the excess portion.

4. The method according to claim 2, wherein the transmitting of the excess portion comprises:
transmitting, by the application process, a position identification of the excess portion to the interface delivery process.

5. The method according to claim 4, wherein the controlling of the touch screen to display the display content comprises:
controlling, by the interface delivery process, the touch screen to display the display content corresponding to the moved display window and the excess portion, based on the position identification of the excess portion.

6. The method according to claim 1, wherein the moving of the display window in the sliding direction comprises:
when the interface delivery process receives the sliding distance and the sliding direction, moving the display window by the sliding distance in the sliding direction.

7. A terminal for responding to a sliding operation, comprising:
a processor;
a touch screen coupled to the processor; and
a memory for storing an operating system including a system process, an application process, and an interface delivery process, wherein:
the application process is configured to draw a display content in a size larger than a size of the touch screen;
the system process, when detecting the sliding operation, acquires a sliding distance and a sliding direction of the sliding operation;
the system process transmits the sliding distance and the sliding direction of the sliding operation to each of the application process and the interface delivery process;
the interface delivery process, when receiving the sliding distance and the sliding direction, moves a display window in the sliding direction, according to the sliding distance; and
the interface delivery process controls the touch screen to display a display content corresponding to the moved display window.

8. The terminal according to claim 7, wherein:
when the application process determines that a display content indicated by the sliding distance exceeds the display content drawn by the application process, the application process draws an excess portion of the display content indicated by the sliding distance according to the sliding distance and the display content; and
the application process transmits the excess portion to the interface delivery process.

9. The terminal according to claim 8, wherein:
when the interface delivery process receives the excess portion, the interface delivery process controls the touch screen to display the display content corresponding to the moved display window and the excess portion.

10. The terminal according to claim 7, wherein:
the application process transmits a position identification of the excess portion to the interface delivery process.

11. The terminal according to claim 10, wherein:
the interface delivery process controls the touch screen to display the display content corresponding to the moved display window and the excess portion, according to the position identification of the excess portion.

12. The terminal according to claim 7, wherein:
when the interface delivery process receives the sliding distance and the sliding direction, the interface delivery process moves the display window by the sliding distance in the sliding direction.

13. A non-transitory storage medium having stored therein instructions regarding an operating system that, when executed by a processor of a terminal, cause the terminal to perform a method for responding to a sliding operation, the terminal having a touch screen, and the operating system including a system process, an application process, and an interface delivery process, wherein the application process is configured to draw a display content in a size larger than a size of the touch screen, the method comprising:
when the system process detects the sliding operation, acquiring a sliding distance and a sliding direction of the sliding operation;
transmitting, by the system process, the sliding distance and the sliding direction of the sliding operation to each of the application process and the interface delivery process;
when the interface delivery process receives the sliding distance and the sliding direction, moving a display window in the sliding direction, according to the sliding distance; and
controlling, by the interface delivery process, the touch screen to display a display content corresponding to the moved display window.
